(19) United States
(12) Patent Application Publication
(10) Pub. No.: US 2010/0190052 A1
(43) Pub. Date: Jul. 29, 2010

(54) BATTERY PACK WITH HIGH AND LOW CURRENT DISCHARGE TERMINALS

(76) Inventors: Umesh Rajani, Anderson, SC (US); Samuel Boyles, Easley, SC (US); Mike Hornick, Anderson, SC (US); Fabio Romero, Simpsonville, SC (US); William S. Miller, Anderson, SC (US); Michael E. Buckner, Central, SC (US); Mark Huggins, Anderson, SC (US); Ryan Harrison, Anderson, SC (US); Taku Ohi, Greer, SC (US); Thomas Parel, Anderson, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/694,438

(22) Filed: Jan. 27, 2010

Related U.S. Application Data
(63) Continuation-in-part of application No. 29/314,346, filed on Mar. 23, 2009.
Application No. 29/314,346 is a continuation-in-part of application No. 29/314,347, filed on Mar. 23, 2009.
Application No. 29/314,347 is a continuation-in-part of application No. 29/314,349, filed on Mar. 23, 2009.
(60) Provisional application No. 61/147,647, filed on Jan. 27, 2009.

(51) Int. Cl. H01M 2/02

(52) U.S. Cl. 429/178

(57) ABSTRACT

A battery pack that is capable of supplying high- and low-current discharge to end products. The battery pack includes a cylindrical housing with a lithium-ion battery cell enclosed within the housing. The housing also includes a first end portion, a second end portion, and a body portion. The first end portion includes a plurality of terminals for electrically connecting to the end product. The terminals include a high-current discharge terminal, a low-current discharge terminal, a battery pack identification terminal, a battery pack temperature terminal, and a positive voltage terminal. The second end portion includes a recess for removably securing the battery pack to an end product, such as a battery charger or a power tool. Included within the battery pack housing is circuitry for controlling the charging and discharging of the battery pack through the low-current discharge terminal.

### RELATED APPLICATIONS

This application claims the benefit of previously-filed, co-pending U.S. Provisional Patent Application No. 61/147,647, filed Jan. 27, 2009, the entire content of which is hereby incorporated by reference.

This application is also a continuation-in-part of U.S. Design Patent Application No. 29/314,346, filed on Mar. 23, 2009, U.S. Design Patent Application No. 29/314,347, filed on Mar. 23, 2009, and U.S. Design Patent Application No. 29/314,349, filed on Mar. 23, 2009, the entire contents of all of which are hereby incorporated by reference.

### BACKGROUND

The present invention relates to battery packs. Battery packs, and in particular smart or intelligent battery packs, often include circuitry for monitoring the charging and discharging operations of the battery packs. Alternatively, an end product, such as a battery charger, may include circuitry for controlling the charging of a battery pack. Conventional battery packs include two terminals (positive and negative) which are used to electrically connect the battery pack with the end product.

U.S. Pat. No. 5,489,484, entitled “BATTERY PACK FOR CORDLESS DEVICE,” discloses a battery pack that includes first and second cells and first, second, and third coaxial pack terminals. A first output voltage between the first and second pack terminals is greater than a second output voltage between the first and third pack terminals. The battery pack provides the multiple output voltages by virtue of electrical connections between the first, second, and third pack terminals and the first and second cells.

### SUMMARY

Although the battery pack disclosed in U.S. Pat. No. 5,489,484 is able to provide multiple output voltages from a single pack, such a battery pack is unable to provide multiple output currents while maintaining a consistent output voltage. Such a battery pack is also incompatible with current battery technology (e.g., lithium-based battery cells).

Embodiments of the invention provide, among other things, a compact battery pack that is capable of supplying high- and low-current discharge to end products. The battery pack includes a cylindrical housing with a lithium-ion battery cell enclosed within the housing. The housing also includes a first end portion, a second end portion, and a body portion. The first end portion includes a plurality of terminals for electrically connecting to the end product. The terminals include a high-current discharge terminal, a low-current discharge terminal, a battery pack identification terminal, a battery pack temperature terminal, and a positive voltage terminal. The second end portion includes a recess for removably securing the battery pack to an end product, such as a battery charger or a power tool. Included within the battery pack housing is circuitry for controlling the charging and discharging of the battery pack through the low-current discharge terminal. In some embodiments, the battery pack housing does not include circuitry for controlling the switching between the low-current discharge terminal and the high-current discharge terminal.

In one embodiment, the invention provides a battery pack that includes a housing, a first terminal, a second terminal, a third terminal, and a controller. The housing has a first end and a second end, and is configured to connect to a plurality of end products. The first terminal, the second terminal, and the third terminal are located at the first end of the housing. The third terminal is configured to work in combination with either the first terminal or the second terminal to provide an output current, and the first terminal is configured to provide a higher output current than the second terminal. The controller is operable to control the output current from at least one of the first terminal and the second terminal.

In another embodiment, the invention provides a battery pack that includes an elongate housing, a first terminal, a second terminal, a third terminal, and a mating rib. The housing has a first end and a second end, and is configured to couple to any of a plurality of devices. The first terminal, the second terminal, and the third terminal are located at the first end of the housing. The first terminal is configured to work in combination with at least one of the second terminal and the third terminal to provide an output current. The second terminal is configured to provide a first output current, the third terminal is configured to provide a second output current, and the first output current is higher than the second output current. The mating rib extends at least partially along the housing, and is configured to provide a physical connection between the battery pack and at least one of the plurality of devices.

In yet another embodiment, the invention provides a battery pack that includes a housing, a first terminal, and a controller. The housing is configured to be coupled to any of a plurality of devices. The first terminal is positioned on the housing, and is configured to work in combination with the a second terminal to provide a first output current when connected to a first of the plurality of devices and a second output current when connected to a second of the plurality of devices. The first output current is higher than the second output current, and the first of the plurality of devices is different than the second of the plurality of devices. The controller is operable to control at least one of the first output current and the second output current.

Other aspects of the invention will become apparent by consideration of the detailed description and accompanying drawings.

### BRIEF DESCRIPTION OF THE DRAWINGS

FIG. 1 illustrates a perspective view of a battery pack according to an embodiment of the invention.

FIG. 2 illustrates a front-side view of the battery pack of FIG. 1.

FIG. 3 illustrates a rear-side view of the battery pack of FIG. 1.

FIG. 4 illustrates a right-side view of the battery pack of FIG. 1.

FIG. 5 illustrates a left-side view of the battery pack of FIG. 1.

FIG. 6 illustrates a top view of the battery pack of FIG. 1.

FIG. 7 illustrates a bottom view of the battery pack of FIG. 1.

FIG. 8 is a diagram of circuitry within a battery pack according to an embodiment of the invention.

FIGS. 9-11 illustrate a battery pack according to another embodiment of the invention.

FIGS. 12-14 illustrate a battery pack according to another embodiment of the invention.

FIGS. 15-17 illustrate a battery pack according to another embodiment of the invention.

FIG. 18 illustrates a system of devices which are compatible with the battery packs of FIGS. 1-17.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

In various embodiments herein, a battery pack is described that includes a housing, at least one battery cell, and a plurality of terminals for electrically connecting the battery pack to an end product. The plurality of terminals includes at least a low-current discharge terminal and a high-current discharge terminal. Circuitry is provided within the housing of the battery pack for controlling the charging and discharging of the battery pack through the low-current discharge terminal. Switching from low-current discharge to high-current discharge is controlled by an end product.

The battery pack can have any of a plurality of different voltage ratings, sizes, and chemistries (e.g., lead-acid, Ni-MH, NiCd, Li-Ion, etc.). The battery pack is attachable to and detachable from a plurality of end products such as power tools, battery chargers, test and measurement equipment, vacuum cleaners, outdoor power equipment, and vehicles. Power tools can include drills, circular saws, jig saws, band saws, reciprocating saws, screw drivers, angle grinders, straight grinders, hammers, impact wrenches, angle drills, inspection cameras, and the like. Battery chargers can include wall chargers, multi-port chargers, travel chargers, and the like. Test and measurement equipment can include digital multimeters, clamp meters, fork meters, wall scanners, IR temperature guns, laser distance meters, laser levels, insulation testers, thermal imagers, lighting testers, moisture meters, and the like. Vacuum cleaners can include stick vacuums, hand vacuums, upright vacuums, carpet cleaners, hard surface cleaners, canister vacuums, broom vacuums, and the like. Outdoor power equipment can include blowers, chain saws, edgers, hedge trimmers, lawn mowers, trimmers, and the like. Vehicles can include electric bicycles, motorcycles, automobiles, trucks, and the like. The battery pack can also be attachable to and detachable from devices such as electronic key boxes, calculators, head phones, cell phones, cameras, motion sensing alarms, flashlights, weather information display devices, and multi-purpose cutters.

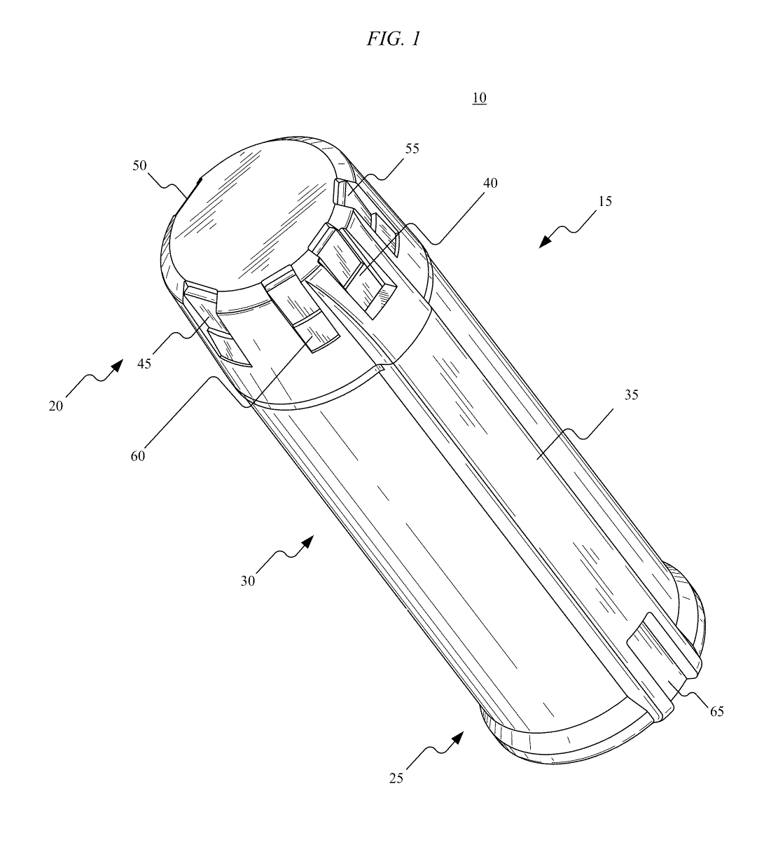

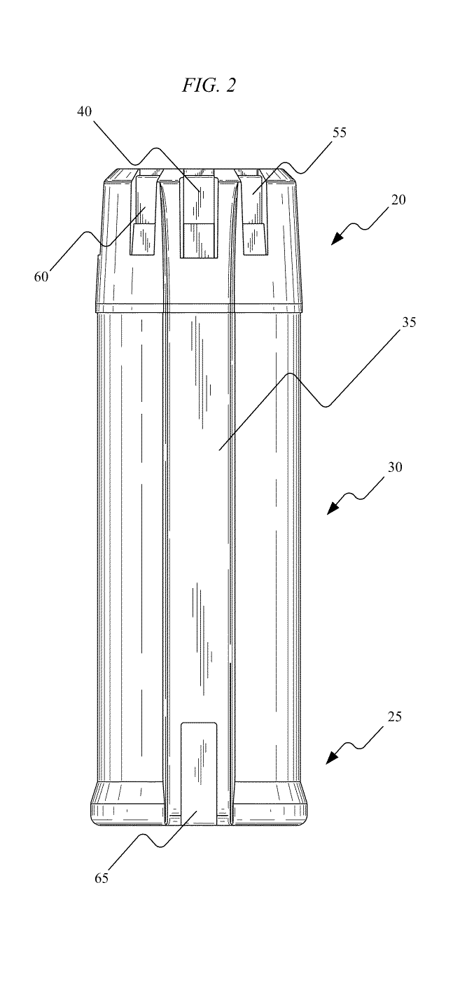

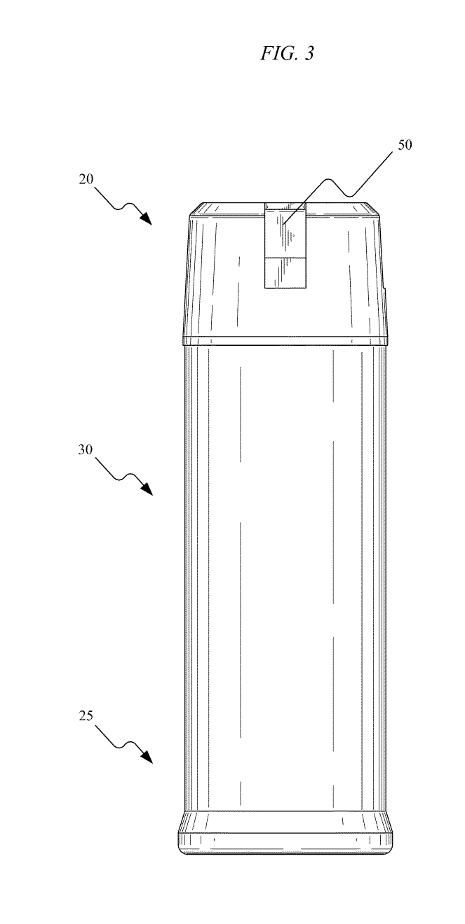

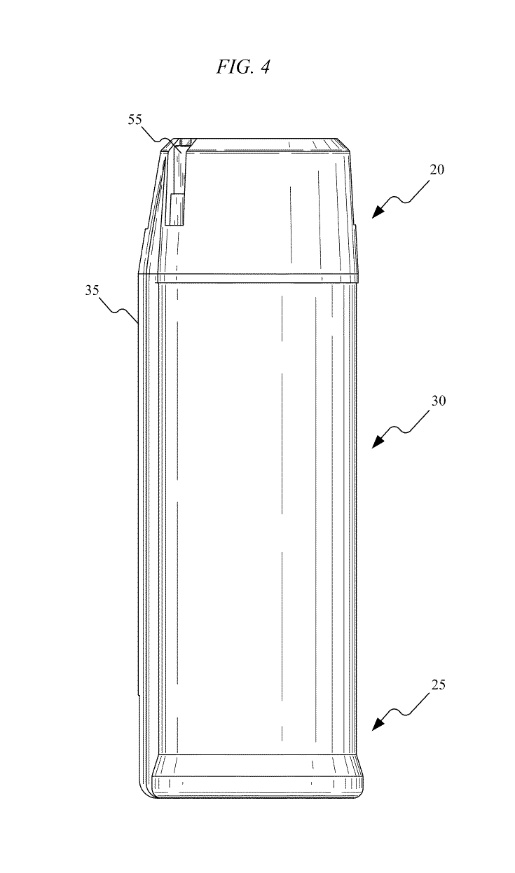

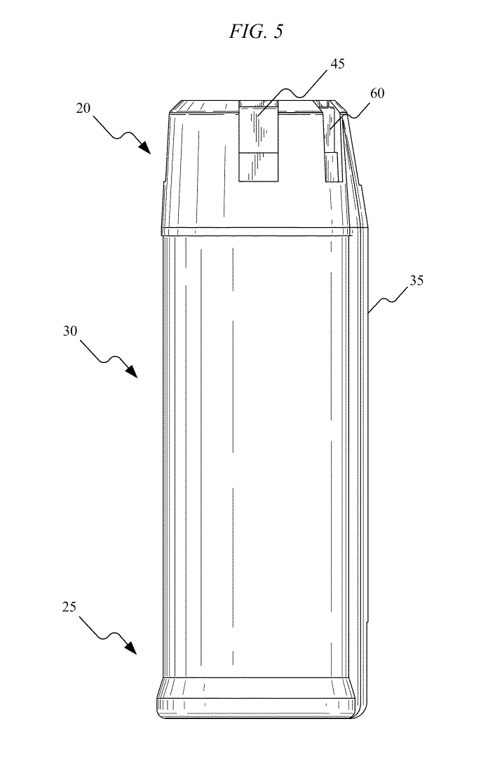

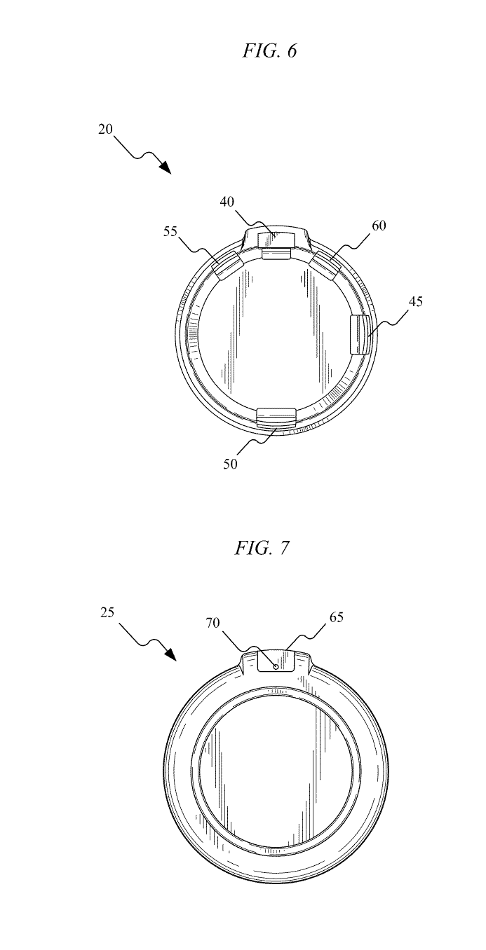

FIGS. 1-7 illustrate a battery pack 10 according to an embodiment of the invention. In the illustrated embodiment, the battery pack 10 has a voltage of 4V and includes a single Li-Ion battery cell. The battery pack 10 also includes a housing 15, a first end portion 20, a second end portion 25, a body portion 30, and a mating rib 35. The first end portion 20 includes a low-current discharge terminal 40, a high-current discharge terminal 45, a positive voltage terminal 50, a pack identification terminal 55, and a pack temperature terminal 60. In some embodiments, additional terminals are included in the battery pack 10, such as independent sets of terminals for each of the high-current discharge and the low-current discharge. The first end portion 20 is tapered from the body portion 30 to a distal end of the first end portion 20 to facilitate the mating of the battery pack 10 with an end product. The body portion 30 is cylindrically-shaped and is positioned between the first end portion 20 and the second end portion 25 of the housing 15. The diameter of the body portion 30 is large enough to accommodate at least one battery cell. The mating rib 35 extends longitudinally from the first end portion 20 to the second end portion 25, and prevents the battery pack 10 from rolling when the battery pack 10 is inserted in, or otherwise coupled to, an end product. The mating rib 35 at least partially surrounds one of the plurality of terminals, and is tapered at the first end portion 20 to facilitate the mating of the battery pack 10 with an end product. The second end portion 25 of the housing 15 includes a recess 65 for securely attaching the battery pack 10 to an end product. The recess 65 includes a vent 70 (see FIG. 7) to prevent the battery pack 10 from becoming pressurized. In some embodiments, the mating rib 35 is located at a different position on the housing 15, such that the mating rib 35 does not at least partially surround one of the plurality of terminals. In other embodiments, the battery pack 10 can include multiple mating ribs 35 positioned symmetrically about the housing 15 to further secure the battery pack 10 to an end product and prevent rolling. In some embodiments, the housing 15 is, for example, sonically-welded together and is waterproof.

In some embodiments, the housing 15 is made of plastic, metal, a composite material, or the like. The battery pack 10 is capable of up to or greater than approximately 2,000 recharge cycles, and has an electric charge of approximately 1.5 mA/hours. The height and width of the battery pack 10 are approximately 4.9 inches and 1.0 inches, respectively, and the approximate weight of the battery pack 10 is 0.14 pounds. The runtime which the battery pack 10 is capable of providing to various products is dependent upon the power requirements of those products. For example, a product that requires a relatively high current, such as a drill or screwdriver, is capable of screwing up to or more than approximately 50 screws on a single charge. Products which require less power, such as headphones, have a continuous runtime of up to or greater than 24 hours on a single charge, and an LED flashlight powered by the battery pack 10 has a continuous runtime of up to or greater than 6 hours on a single charge.

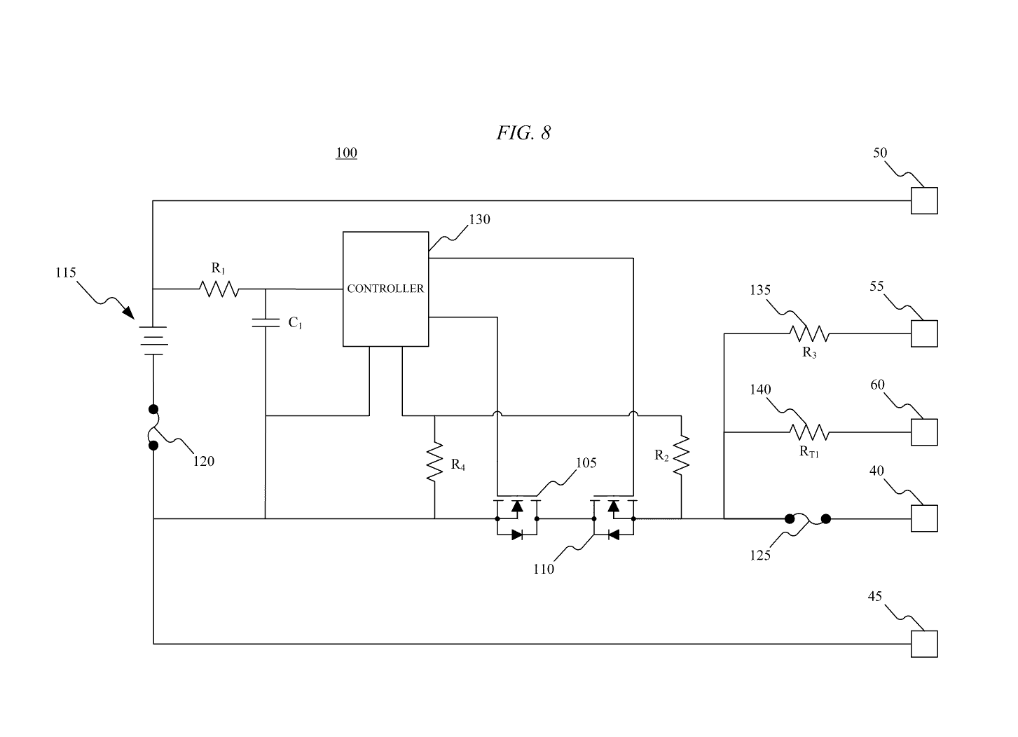

FIG. 8 is a diagram of a control circuit 100 that is located within the battery pack 10. The circuit 100 includes the low-current discharge terminal 40, the high-current discharge terminal 45, the positive voltage terminal 50, the pack identification terminal 55, and the pack temperature terminal 60 for interfacing with end products. The circuit 100 also includes a plurality of switches, such as first and second field-effect transistors (“FETs”) 105 and 110, a battery cell 115, a first fuse 120, a second fuse 125, a controller 130 (e.g., a processor, a microprocessor, a microcontroller, an integrated circuit, etc.), a battery pack identification resistor 135, and a thermistor 140. The controller 130 provides signals to the first and second FETs 105 and 110 to control the charging and discharging of the battery pack 10 through the low-current discharge terminal 40. The battery pack identification resistor 135 is used to provide, via the pack identification terminal 55, a voltage to an end product that allows the end product to identify the battery pack 10. The thermistor 140 is used to provide, via the pack temperature terminal 60, a voltage to an end product that allows the end product to determine a temperature (e.g., a battery cell temperature) of the battery pack 10.

The terminals of the battery pack 10 are positioned to electrically connect with a plurality of different end products. In one embodiment, an end product that requires a low current discharge (e.g., less than 5 amps) electrically connects to only the positive voltage terminal 50 and the low-current discharge terminal 40. The controller 130, the first FET 105, the second FET 110, and the second fuse 125 are used to limit and control the current provided to the end product by the battery pack 10, or a charging current from the end product. In some embodiments, when the battery pack 10 is connected to a battery charger, the positive voltage terminal 50, the low-current discharge terminal 40, the pack identification terminal 55, and the pack temperature terminal 60 are each electrically connected to the battery charger.

In another embodiment of the invention, an end product that requires high-current discharge from the battery pack 10 (e.g., greater than 5 amps) electrically connects to only the positive voltage terminal 50 and the high-current discharge terminal 45. The battery pack 10 is able to provide up to, for example, 30 Amps of current to the end product. The first fuse 120 is included in the battery pack 10 to prevent the battery pack 10 from providing a current that could damage either the end product or the battery pack 10 (e.g., a current greater than 30 amps). Unlike the low-current discharge terminal 40, circuitry for controlling the amount of current discharged from the high-current discharge terminal 45 is not located within the battery pack 10, but is instead in the end product. As a result, the battery pack 10 does not require additional heat sinks or control circuitry within the housing 15, which allows the battery pack 10 to remain compact. In other embodiments, circuitry for controlling the amount of current discharged from the high-current discharge terminal 45 is located within the battery pack 10.

In other embodiments, an end product electrically connects to the low-current discharge terminal 40 and the high-current discharge terminal 45, as well as the positive voltage terminal 50. In such embodiments, circuitry is located within the battery pack 10, the end product, or both the battery pack 10 and the end product for controlling the discharge from the low-current discharge terminal 40 and the high-current discharge terminal 45. As an illustrative example, some end products require current to be discharged at different rates at different times. During normal operation, the end product may require less than 5 amps of current, which can be supplied by the low-current discharge terminal 40. However, during some operating conditions, a higher current discharge is required. For example, if an end product includes a motor that is not continuously operated (e.g., is only energized for short periods of time), the battery pack 10 is switched from the low-current discharge terminal 40 to the high-current discharge terminal 45 to supply the necessary high-current discharge to the end product when the motor is energized.

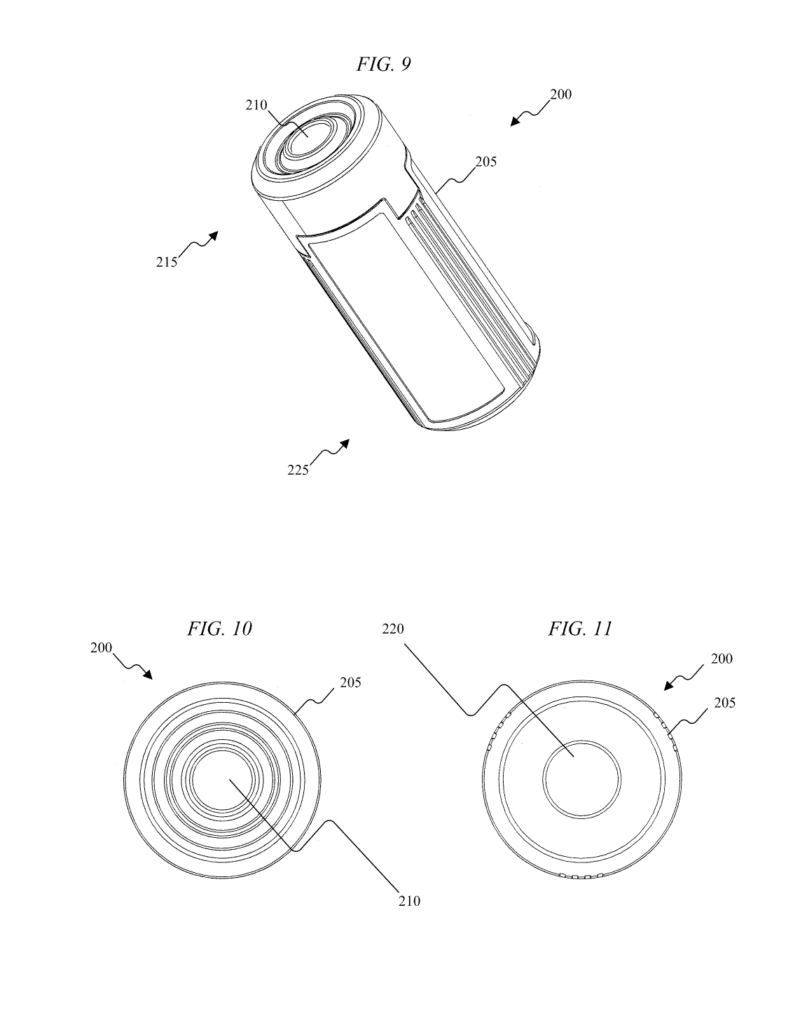

Another embodiment of a battery pack 200 having high- and low-current discharge is illustrated in FIGS. 9-11. The battery pack 200 has a cylindrical housing 205 and only two terminals. A first terminal 210 is positioned at a first end 215 of the cylindrical housing 205, and a second terminal 220 is positioned at a second end 225 of the cylindrical housing 205. The battery pack 200 includes control electronics similar to those in the battery pack 10 and described with respect to FIG. 8. However, because the battery pack 200 includes only first and second terminals 210 and 220, both the high- and low-current discharge are controlled by the control electronics within the battery pack 200. In some embodiments, the battery pack 200 identifies the device to which it is attached to determine whether to use the high-current or low-current discharge control circuitry within the battery pack 200. In other embodiments, the battery pack 200 is capable of providing a range of output currents from low to high. The output current is adjusted based on the requirements of the device and no switching between low-current or high-current control circuitry is required. For example, the battery pack 200 is capable of providing from 0-30 A of current. Protection circuitry is included within the battery pack 200 to prevent the battery pack 200 from providing an output current that could damage the device or the battery pack 200 (e.g., a current greater than 30 A).

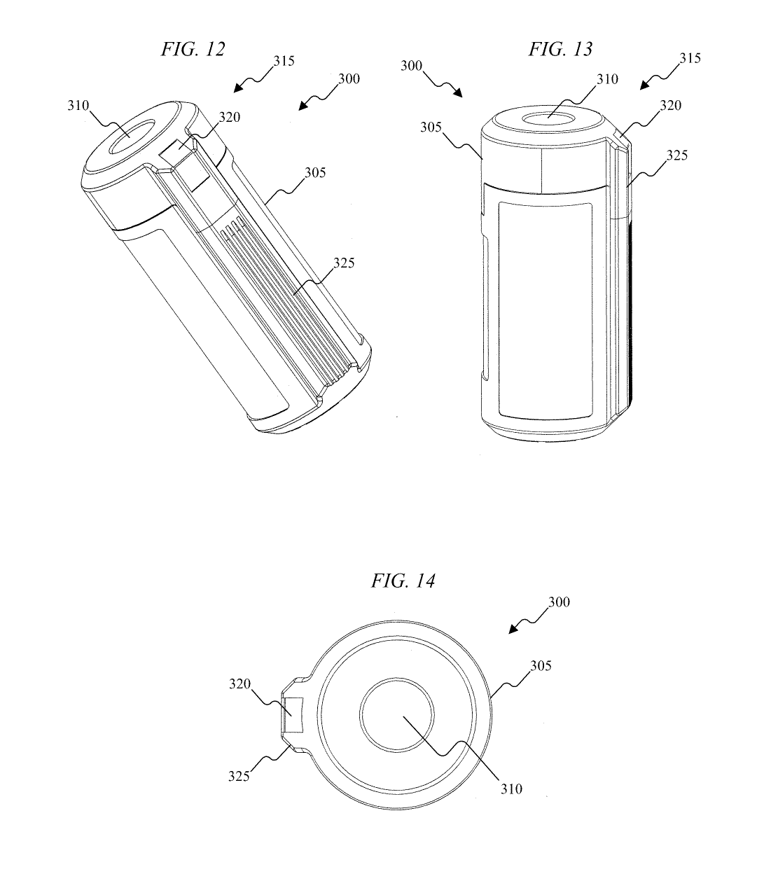

FIGS. 12-14 illustrate another two-terminal battery pack 300. The battery pack 300 is similar to the battery pack 200 described with respect to FIGS. 9-11. However, the battery pack 300 includes a cylindrical housing 305, a first terminal 310 positioned at a first end 315 of the housing 305 and a second terminal 320 positioned on a mating rib 325. Positioning the second terminal 320 on the mating rib 325 ensures that the battery pack 300 is properly inserted into or coupled to a device. The control circuitry included in the battery pack 300 is similar to the control circuitry included in the battery pack 200.

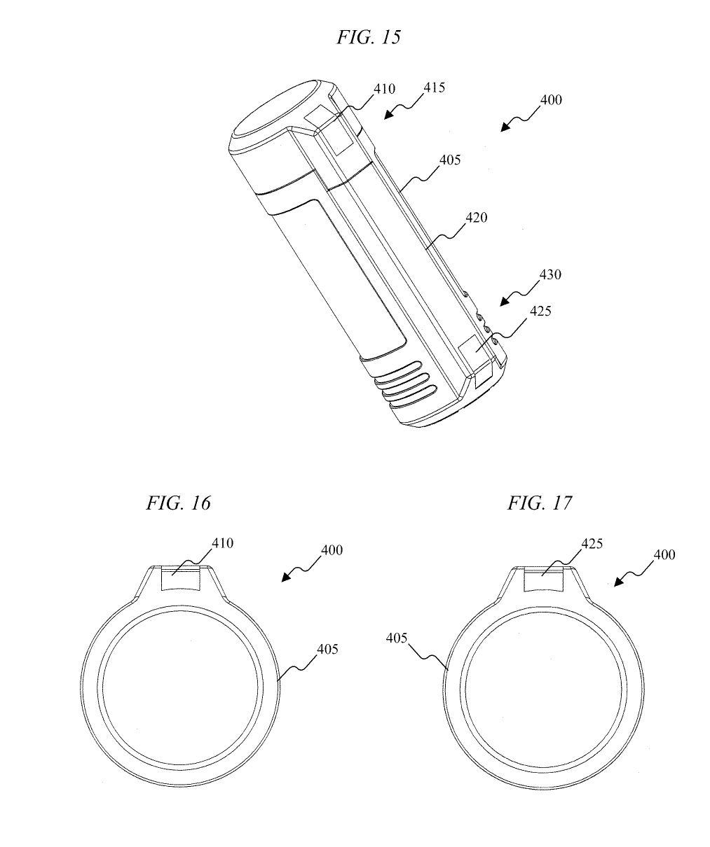

FIGS. 15-17 illustrate a two-terminal battery pack 400. The battery pack 400 is similar to the battery pack 200 described with respect to FIGS. 9-11 and the battery pack 300 described above with respect to FIGS. 12-14. However, the battery pack 400 includes a cylindrical housing 405, a first terminal 410 positioned at a first end 415 of a mating rib 420 and a second terminal 425 positioned at a second end 430 of the mating rib 420. The control circuitry included in the battery pack 400 is similar to the control circuitry included in the battery packs 200 and 300.

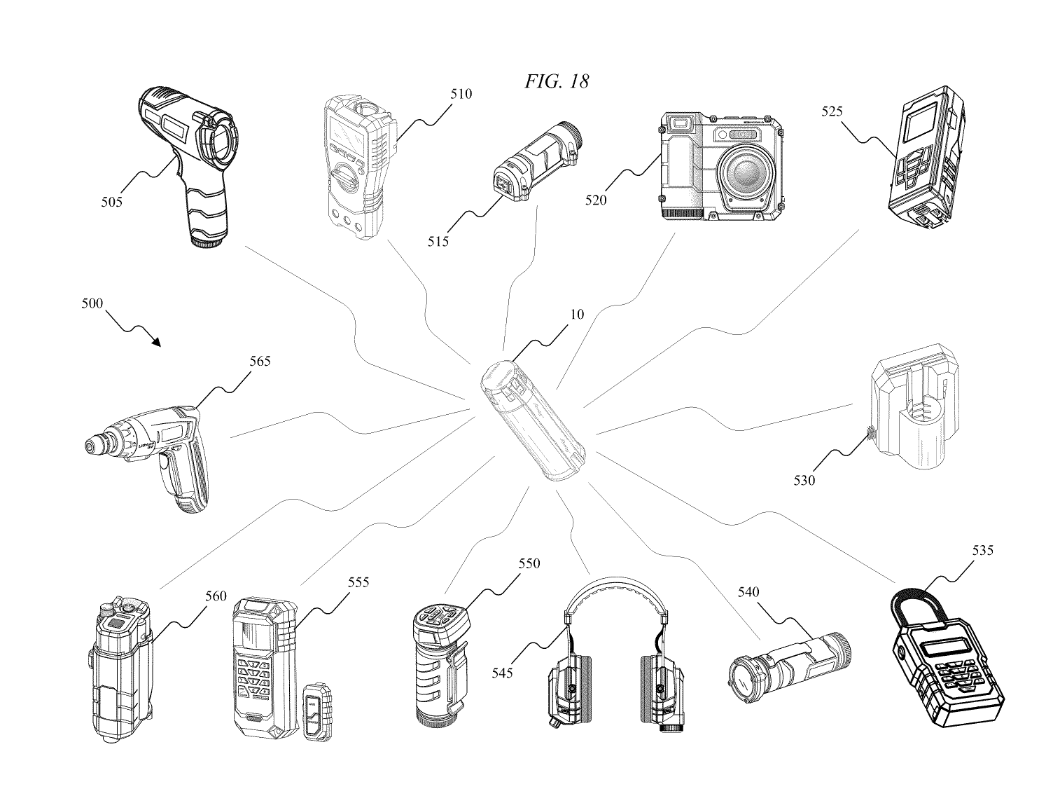

The battery packs 10, 200, 300, and 400 described above are compatible with a plurality of devices. Such compatibility enables, for example, the battery pack 10 or a group of battery packs 10 to provide power to a group of devices that are used daily or are required to complete a project. FIG. 18 illustrates a system 500 of devices which are compatible with the battery pack 10. The devices include an infrared (“IR”) temperature gun 505, a digital multimeter (“DMM”) 510, a portable power source 515, a digital camera 520, a laser distance measuring device 525, a single-port battery charger 530, an electronic lock 535, a flashlight 540, noise-canceling headphones 545, a digital music player 550, a motion sensing alarm with remote 555, a self-leveling laser 560, and a drill 565, although the battery pack 10 is compatible with other devices as well (e.g., a saw, snips, etc.). As an illustrative example, the project may require the use of a drill, snips, a flashlight, headphones, and a charger. One or more of the battery packs 10 are used to power all of the devices, and the battery pack is selectively connectable to each of the devices. Particularly, each of the devices includes an interface which is capable of receiving the battery pack 10 and electrically connecting the terminals of the battery pack 10 to the device. The configuration of each device's interface depends on the power requirements of the device. Examples of such interfaces are disclosed in U.S. Design Patent Application No. 29/314,346, filed on Mar. 23, 2009, U.S. Design Patent Application No. 29/314,347, filed on Mar. 23, 2009, and U.S. Design Patent Application No. 29/314,349, filed on Mar. 23, 2009, the entire contents of all of which were previously incorporated by reference. Accordingly, one or more battery packs 10 are able to be packaged, sold, or otherwise combined with various combinations of any of the previously described products to provide a system of tools, devices, and power sources which is able to meet the operational and functional requirements of a user.

Thus, the invention provides, among other things, a battery pack that includes both low- and high-current discharge terminals. Circuitry for controlling the charging and low-current discharge of the battery pack is located within the housing, and circuitry for controlling the high-current discharge of the battery pack is located in an end product. Various features and advantages of the invention are set forth in the following claims.

What is claimed is:

1. A battery pack comprising:
a housing having a first end, a second end, and at least one battery cell, the housing configured to connect to a plurality of end products;
a first terminal located at the first end of the housing;
a second terminal located at the first end of the housing;
a third terminal located at the first end of the housing, the third terminal configured to work in combination with either the first terminal or the second terminal to provide an output current,
wherein the first terminal is configured to provide a higher output current than the second terminal; and
a controller operable to control the output current from at least one of the first terminal and the second terminal.

2. The battery pack of claim 1, further comprising a battery pack temperature terminal located at the first end of the housing, and a pack identification terminal located at the first end of the housing.

3. The battery pack of claim 1, further comprising a mating rib extending between the first end of the housing and the second end of the housing.

4. The battery pack of claim 3, wherein the mating rib is configured to secure the battery pack to at least one of the plurality of end products.

5. The battery pack of claim 4, wherein the mating rib includes a recess for securing the battery pack to at least one of the plurality of end products.

6. The battery pack of claim 1, wherein the first terminal is configured to connect to a first end product and the second terminal is configured to connect to a second end product.

7. The battery pack of claim 1, wherein the battery pack includes a single battery cell.

8. The battery pack of claim 1, further comprising a fourth terminal configured to work in combination with either the first terminal or the second terminal to provide a second output current.

9. A battery pack comprising:
an elongate housing having a first end, a second end, and at least one battery cell, the housing configured to couple to any of a plurality of devices;
a first terminal, a second terminal, and a third terminal located at the first end of the housing, the first terminal configured to work in combination with at least one of the second terminal and the third terminal to provide an output current,
wherein the second terminal is configured to provide a first output current, the third terminal is configured to provide a second output current, and the first output current is higher than the second output current; and
a mating rib extending at least partially along the housing and configured to provide a physical connection between the battery pack and at least one of the plurality of devices.

10. The battery pack of claim 9, further comprising a battery pack temperature terminal located at the first end of the housing, and a pack identification terminal located at the first end of the housing.

11. The battery pack of claim 9, further comprising a controller which is operable to control at least one of the first output current and the second output current.

12. The battery pack of claim 9, wherein the mating rib is configured to secure the battery pack to at least one of the plurality of end products.

13. The battery pack of claim 12, wherein the mating rib includes a recess for securing the battery pack to the at least one of the plurality of end products.

14. The battery pack of claim 9, wherein the first terminal is configured to connect to an interface of a first device, and the second terminal is configured to connect to an interface of a second device.

15. A battery pack comprising:
a housing including at least one battery cell and configured to be coupled to any of a plurality of devices;
a first terminal configured to work in combination with a second terminal to provide a first output current when connected to a first of the plurality of devices and a second output current when connected to a second of the plurality of devices,
wherein the first output current is higher than the second output current, and the first of the plurality of devices is different than the second of the plurality of devices; and
a controller operable to control at least one of the first output current and the second output current.

16. The battery pack of claim 15, wherein the housing includes a first end and a second end.

17. The battery pack of claim 16, further comprising a battery pack temperature terminal located at the first end of the housing, and a pack identification terminal located at the first end of the housing.

18. The battery pack of claim 16, wherein the first terminal and the second terminal are positioned at the first end of the housing.

19. The battery pack of claim 15, wherein the second output current is controlled by the second of the plurality of devices.

20. The battery pack of claim 15, further comprising a mating rib extending at least partially along the housing and configured to provide a physical connection between the battery pack and at least one of the plurality of devices.

21. The battery pack of claim 20, wherein the mating rib is configured to secure the battery pack to at least one of the plurality of end products.

22. The battery pack of claim 21, wherein the mating rib includes a recess for securing the battery pack to the at least one of the plurality of end products.

23. The battery pack of claim 15, wherein the second terminal is a low-current discharge terminal.

24. The battery pack of claim 15, wherein the second terminal is a high-current discharge terminal.
